(19) United States
(12) Patent Application Publication
(10) Pub. No.: US 2013/0270782 A1
(43) Pub. Date: Oct. 17, 2013

(54) DUAL SLIDERS WITH FLEXIBLE HINGE

(71) Applicant: Kaj Gyr, Nelson (CA)

(72) Inventor: Kaj Gyr, Nelson (CA)

(21) Appl. No.: 13/862,138

(22) Filed: Apr. 12, 2013

Related U.S. Application Data
(60) Provisional application No. 61/624,012, filed on Apr. 13, 2012.
(60) Provisional application No. 61/758,142, filed on Jan. 29, 2013.

(51) Int. Cl. B62B 13/00

(52) U.S. Cl. CPC B62B 13/005
USPC 280/17

(57) ABSTRACT

A sliding device for riding in snow includes dual sliding boards, each with bodies that have horizontal and vertical axes. A flexible hinge is located between the boards and along vertical axes of the boards.

### CROSS-REFERENCE TO RELATED APPLICATIONS

This application claims the benefit of the following U.S. Provisional Patent Applications: (1) Ser. No. 61/624,012 filed Apr. 13, 2012; and (2) Ser. No. 61/758,142, filed Jan. 29, 2013, both applications which are incorporated herein by reference for all purposes.

### BACKGROUND

Several forms of articulating sleds are on the market. Generally speaking, they have some form of hinge which is placed between the boards, connecting the front and rear portions of the sled. These sleds and articulating snowboards are the most similar to the present inventive concepts.

The prior art locates the hinges between the two portions along the longitudinal axis of the boards, which ushers in some dynamics that are not ideal in terms of how the rear portion is shaped, and how turning forces are distributed. The closest prior art, U.S. Pat. No. 5,618,051 of Kobylenski discloses a two-piece snowboard held together with elastic bands. This design is problematic for snowboards, as the axial moments of turning need to be much closer to the boarder's feet in order to maintain adequate control. The design also yields a very skittish feel, with no damping and very uneven turns (due to the boards being jostled back and forth by bumps). With sledding, unlike snowboarding, such a placement of elastic bands can work, as the sledder can apply much more force to the front board with his hands or feet when in seated or kneeling positions, thereby dampening the turn and making it smoother. This is not ideal however. There are myriad ways of allowing for better turning dynamics in a winter slider, as outlined herein.

FIGS. 1-2 show two-piece snowboards of the prior art with various forms of flexible connectors. Due to their placement, they require the rear board to be flat in the forward area, which is obviously not good. Also, being that the boards are not actually in contact with each other they have a tendency to move back and forth relatively unrestrained—a real problem. Minimizing the lever arm and providing additional dampening of turning forces is essential, and conventional systems cannot achieve either of these requirements.

Also, in the prior art, attachments for the hinges are small, thus they magnify forces instead of distributing them. Thus they would not be good for use with foam boards of any type, unlike the twisting swivels, twisting joints, and flexible rods of the present inventive concept.

A number of advantages may be derived from locating the hinge or hinging means along a vertical axis relative to the horizontal axis of the boards, and over the boards as opposed to in-between them. Dampening of steering forces is thus optimized, creating a more controllable sled. Also, a compound hinge dynamic is possible, allowing the front and back boards to pivot on Y and Z axes relative to one another. Even distribution of forces is imperative with foam or other low-density fragile materials, and the following designs address this.

Advantages of the present invention over conventional sleds:
Ideal for foam or sandwich-style sleds.
Lightweight and robust.
Easy to manufacture.
Steering may be adjustably dampened.
The sled portions can pivot on both Y and Z axes, creating a “compound” hinge effect.
Front and rear boards may be easily detached.

### BRIEF DESCRIPTION OF THE DRAWINGS

FIG. 1 shows an elevational view of the prior art flexible band, situated between the boards.

FIG. 2 shows and elevational view of another prior art flexible band.

FIG. 3 shows an elevational view of the present inventive concept with flexible rod.

FIG. 4 shows an elevational view of the present inventive concept with angled attachment.

FIG. 5 shows an elevational view of a flexible rod and attachment cap.

FIG. 6 shows an elevational view of planar surfaces and flexible rod.

FIG. 7 shows and elevational view of a co-planer setup and twisting swivel.

FIG. 8 shows a plan view of a board attachment and it's placement.

FIG. 9 shows an elevational view of a twisting swivel with a crease.

FIG. 10 shows and elevational view of a twisting swivel with a diagonal crease.

FIG. 11 shows and elevational view of a flexible band with board attachment on top.

FIG. 12 shows an elevational view of a flexible band with shock absorber.

FIG. 13 shows an elevational view of a pin pivot.

FIG. 14 shows an elevational view of a short hourglass-shaped twisting joint.

FIG. 15 shows a close-up of an hourglass twisting joint.

FIG. 16 shows an elevational view of an hourglass twisting joint on a standard tip.

FIG. 17 shows an elevational view of another shape of twisting joint.

FIG. 18 shows an elevational view of a flexible band holding a twisting joint together.

FIG. 19 shows a front view of the top (rear) snowboard, and the orientation of the twisting joint.

FIG. 20 shows an elevational view of a top twisting joint.

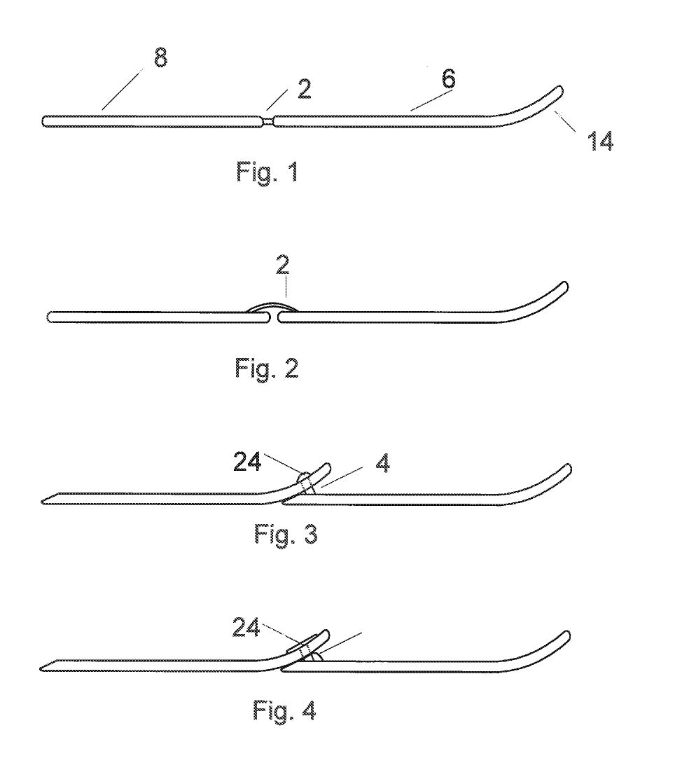

### REFERENCE NUMERALS IN DRAWINGS

2—Flexible Band
4—Flexible Rod
6—Front Board
8—Rear Board
10—Board Attachment
12—Planer Surface
14—Board Tip
16—Crease
18—Shock Absorber
20—Angled attachment
22—Twisting Joint
24—Attachment Cap
26—Pin
28—Integrated Pin
30—Notch
32—Top twisting joint
34—Static pin

### DESCRIPTION

The primary benefits of the present invention are derived from the flexible coupling of two sliding boards, which allows for better steering, enhanced performance in powder snow, and decreased torque moment on the boards. As will be described and is shown in FIGS. 3-20, there is a sliding device for riding in snow that includes dual sliding boards, each with bodies that have horizontal and vertical axes. A flexible hinge located between the boards and along vertical axes of the boards.

Through better distribution of forces, using foam for the boards is an option, unlike with designs of the prior art.

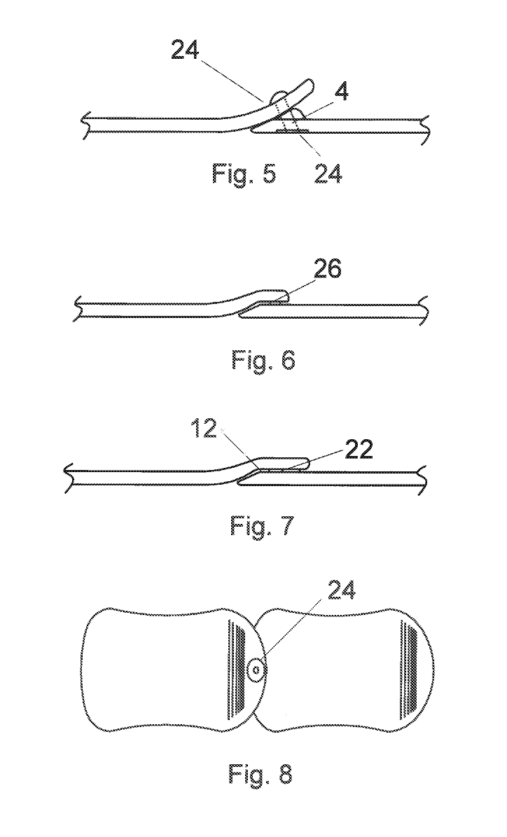

Unlike with two-piece snowboards, the position of the sledder, be it sitting, kneeling, or prone, allows for much greater forces to be applied to the two boards. FIGS. 3-5 show various forms of the sled with flexible rods. The flexible rods may be at any angle between 0-90 degrees from the horizontal. The flexible rods are preferably made from an elastomeric material that can withstand both torsional and longitudinal flexing. Various durometers of urethane are good candidates for this. The rod is attached to the rear top portion of the front board, and the forward top portion of the rear board in a manner that distributes loads and minimizes the possibility of putting undue stress on the surrounding board. FIG. 4 shows an angled attachment, the upper surface of which is substantially parallel to the plane of the rear board. This allows for a tighter interface and thus less laxity when turning. FIG. 5 shows an angled flexible rod that extends down to the bottom surface of the front board, connecting to a board attachment on the lower surface of the front board, thus distributing loads evenly.

FIG. 6 shows co-planer surfaces on the forward top portion of the rear board, and a flexible rod. A static (no-twisting) rod may be used also. This configuration allows for co-planer movement of the boards. FIG. 7 shows planer surfaces with a broad twisting joint. This twisting joint is bonded or attached between both boards. The tail of the front board and tip of the rear board are parallel, making for co-planer rotation. The twisting joint is made from resilient, relatively low-durometer foam, gel, rubber, or other resilient material. It may have grooves or facets on one or both sides that have matching grooves at the point of attachment to the board. This keeps the twisting joint from sliding at its interface with the boards, transferring all twisting to the joint itself. Twisting joints allow the boards to pivot on the Z axis, as they deform slightly with lateral pivoting of the boards. They dampen rotational movement by deforming, making the sled more controllable. Not much deformation is necessary, as the boards only need to pivot several degrees relative to one another in order to initiate a turn. The twisting joint may be quite thin (roughly ¼″), or thicker. Of course making it thicker will increase its deformation. FIG. 8 shows a plan view of the sled with an attachment cap, illustrating the joint's placement.

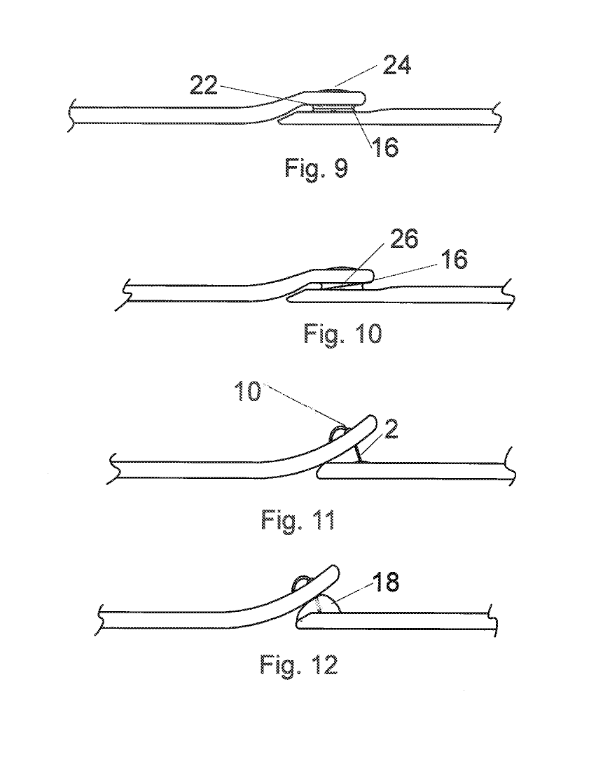

FIG. 9 shows a broad twisting joint with a crease in the middle. The crease allows for more rotational movement. The pin further reinforces the connection of the flexible swivel between the two boards, preventing tearing of the flexible swivel. It may also be designed to allow for a given range of movement, both axially (relative to the Z axis) and longitudinally, thus reducing the likelihood of breakage.

FIG. 10 shows a twisting joint with a diagonal crease. Among other things, the diagonal crease allows for a compound hinge dynamic (pivoting concurrently in more than one axis) The crease may actually be the junction between two separate pieces of flexible swivel (if varying durometers are preferred) or a simple indentation in the same piece. It may also be a different material, such as a sheet of harder plastic. The flexible swivel may also be substantially hourglass-shaped. Tapering in the middle increases its flexibility in all axes.

FIGS. 11-12 show a flexible band between the two boards. They are attached to the boards in methods germane to the art—buckles, snaps, Velcro, etc. Such an arrangement does not effectively dampen steering forces, but depending on the configuration of the sled, that may be fine. FIG. 12 shows a shock absorber under the forward portion of the rear board, which keeps tension on the elastic band (note deformation of the shock absorber under tension from the flexible band), while providing some shock absorption. The sled may be folded on itself for storage with flexible bands.

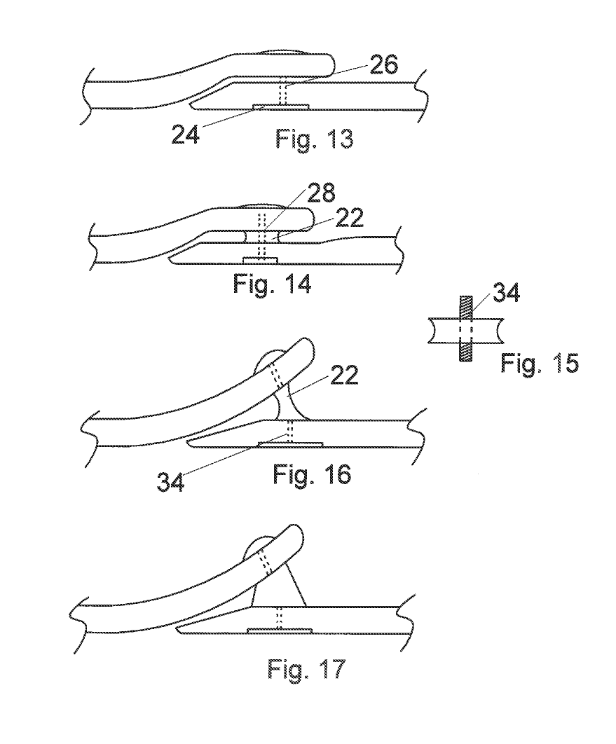

FIG. 13 shows a simple static pin which connects the two boards, around which the two boards pivot. The pin takes the place of the flexible rod, merely serving as a free pivot without dampening.

FIG. 14-16 show an hourglass-shaped twisting pivot with integrated (or static) pin. The hourglass-shaped pivot is similar to a “Power Joint” on a windsurfer—the joint between the mast base and the board which allows the mast to pivot freely. It doesn't need to be as beefy for sleds, but the dynamic is similar. The integrated pin is co-molded or otherwise bonded within the twisting pivot, with means (e.g., screw-type) for attaching the pivot to both boards (preferably in conjunction with a broad attachment cap). The twisting pivot may be relatively short, or longer, as in FIGS. 16-17. It may be symetrically formed (FIGS. 14-15), or asymetric, as in FIGS. 16-17. There is more room for it with upturned tips, but it may also be incorporated in a planer setup, as FIG. 14 demonstrates. It may take many different shapes—anything that provides twisting and the flexible dynamic is fine.

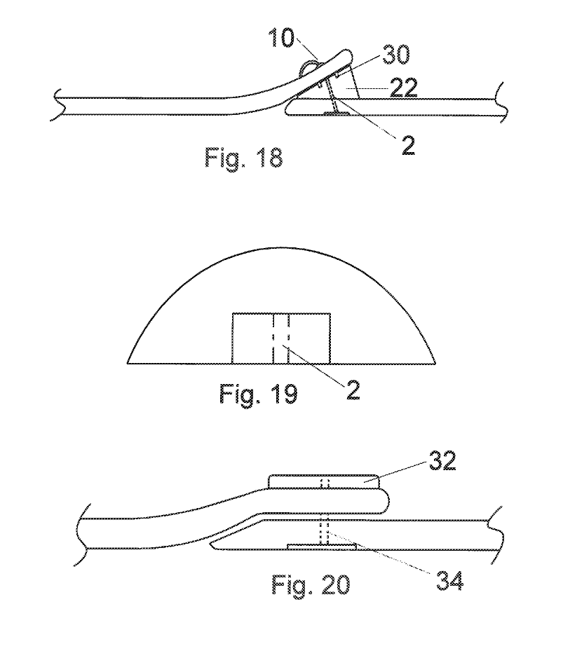

A very simple and robust embodiment is that pictured in FIGS. 18-19. By using a flexible band to hold the twisting joint together (and make it easily detachable) the joint is stout, flexible, and easy to make, while providing optimal control. Notches may be formed in both the twisting joint and the adjoining surfaces of the boards. Such notches anchor the twisting joint, insuring that rotation is taking place in the joint itself. Depending on the overall design, this may not be necessary.

FIG. 19 is a front view of the twisting joint in relation to the tip of the rear board. The flexible band (or rod) is shown in the center. The front board is not shown.

If a co-planer configuration is used (as in FIGS. 6-7, 9-10, 13-14, 20) an alternative to the previous twisting joints is possible. Putting the twisting joint on top of the two boards allows for full board thickness—a real concern with foam boards due to their relative fragility. The static pin would be embedded or otherwise bonded to the twisting joint, and attached in a manner which inhibits rotation on the front board. The twisting joint itself is bonded or attached to the rear board, thereby translating all twisting forces to the twisting joint itself. The top twisting joint may also be used with non co-planer versions.

### Operation

Due to optimized steering dampening and multi-axis pivoting of the boards, the sled performs very well whether sitting, kneeling, or prone.

Steering is a very dynamic process, and can be easily tailored to the conditions. On ice or hardpack the sled tracks very well, with the rear board essentially acting as a trailer, following the front board's turning. Overall it's a very fluid and active feel, as the upper body may also be engaged, leaning into the turn.

### ADDITIONAL EMBODIMENTS MAY INCLUDE ANY COMBINATION OF THE FOLLOWING

Varying widths and sidecuts of the boards.

Various combinations of materials for the elastic bands/rods, or twisting joints.

The addition of footrests, handholds, seats, etc. in methods germane to the art.

Varying angles of the rod attachments, allowing for a compound hinge dynamic.

Two or more boards coupled together.

Varying shapes of the flexible rod, such that it has anisotropic qualities.

A “buckle” means for quickly attaching/detaching the two boards using a flat flexible band with holes and corresponding peg, or “keyhole” means, with a rod-shaped flexible band that has wider portions which fit into a corresponding keyhole.

A means for tightening the tension of the flexible rods/twisting joint, thus altering the dampening characteristics.

A means for changing the twisting joints, flexible rods/bands, thereby altering turning dynamics.

### CONCLUSIONS, RAMIFICATIONS, AND SCOPE

Clearly there are a variety of forms this hinging means may take. Sleds made specifically for Freestyle, Carving, Hardpack, Powder, and Racing could all incorporate various forms of hinge flex, materials, board thickness, weight, adjustability, bottom profiles, rod configurations, handles, etc. Materials and methods germane to the art may be liberally employed in various combinations. Thus the scope of the invention should not be limited to the specific embodiments described in this specification, but rather to the range of options the designs outlined herein embody.

I claim:

1. A sliding device for riding in snow, comprising:
dual sliding boards, each with bodies that have horizontal and vertical axes; and
a flexible hinge located between the boards and along vertical axes of the boards.
